(19) United States
(12) Patent Application Publication
(10) Pub. No.: US 2005/0242915 A1
(43) Pub. Date: Nov. 3, 2005

(54) Multi-tap coil

(76) Inventors: Wilhelmus Mathias Clemens Dolmans, Eindhoven (NL); Cicero Silveira Vaucher, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/521,657

(22) PCT Filed: Jun. 25, 2003
(86) PCT No.: PCT/IB03/02852

§ 371 Date: Jan. 18, 2005

(30) Foreign Application Priority Data
Jul. 23, 2002 (EP) 02077994.8

(51) Int. Cl. H01F 21/12

(52) U.S. Cl. 336/150

(57) ABSTRACT

The invention relates to multi-band resonator circuits with inductors and capacitors. These resonator circuits are realized on integrated circuits. The inductors are realized according to the invention within one single coil comprising a center (2) tap and intermediate taps (4, 6).

The invention relates to an integrated circuit with at least two resonator circuits, in particular for multi-band operation, each resonator circuit comprising at least two inductors, each resonator circuit comprising at least one capacitor, where said at least two inductors and said capacitor provide one resonant circuit, respectively. The invention further relates to telecommunication equipment and the use of an inventive integrated circuit.

In a multi-band broadcast or telecommunication system it is common practice to use multiple resonators to tune to respective multiple frequency bands. These resonators are implemented by use of inductors and capacitors. The integration of inductors in integrated circuits is critical with respect to the chip area and the quality factor.

From U.S. Pat. No. 5,892,425 an inter-wound spiral center-tapped inductor is disclosed. This center-tapped inductor is implemented on an integrated circuit with an insulating, semi-insulating or semi-conducting substrate, having an optional ground plane. A three-terminal center-tapped inductor is disclosed, where a pair of inter-wound spiral conductor are co-arranged on the substrate. The inter-wound spiral conductors are formed by a respective pair of thin metal traces disposed on or within a substantially common plane.

By using a described multi-turn coil with a central tap the resonance quality factor is decreased because of the increase in losses caused by the crossings between the turns. In case of M resonator circuits, M inductive coils have to be provided which require more, expensive silicon area.

It is further known to use one turn coils where no crossings between the turns occur. These coils have the drawback that they require an increased amount of silicon area. For example a two-turn coil has an inductance of L˜2a² (with a as the radius of the two-turn coil) and where a single-turn coil has an inductance of L˜b² (where b is the radius of the single-turn coil). That means that a single-turn coil must have a radius of 1,4 times of the two-turn coil radius to get the same inductance. Furthermore, M resonator circuits require M coils for multi-mode operation.

It is therefore an object of the invention to provide resonator circuits with reduced substrate use. It is another object of the invention to provide an inductor with a good resonance quality factor. It is yet another object of the invention to provide for easy integration of an inductor in integrated circuits.

These objects of the invention are solved by an integrated circuit where said inductors for said at least two resonator circuits are provided by one coil, and where said coil is mounted on the chip area of said integrated circuit.

In case two inductors are used for one resonator circuit, and two resonator circuits are used for multi-band operation, four inductors have to be provided. According to the invention, these four inductors are provided by one coil. This one coil has multiple taps, segments between the taps providing an inductor, respectively. By using only one coil, the required substrate space may be reduced. It is possible to realize more than one resonator circuit within one single coil.

A measure according to claim 2 is preferred. The center tap divides said coil into two branches. Intermediate taps are arranged between said center tap and connection leads of said coil. The connection leads are the outer terminals of the coil. By arranging intermediate taps, it is possible to provide more than two inducting branches within one coil, which is already branched by one center tap.

By providing intermediate taps according to claim 3, it is possible to dimension said inductors according to resonator circuit needs, where the inductance is determined by the length of the segments.

With an arrangement according to claim 4, it is possible to provide for resonator circuits with equally sized inductors. For instance said intermediate taps divide said branches from said center tap to said connection leads into two segments, respectively, where the segments on each side of the center tap are equally sized.

An integrated circuit according to claim 5 is advantageous, as the inductance of the inductors is determined by the length of the segments. It is possible that a segment between said center tap and said first intermediate taps on each branch provides first inductors and that a segment between said center tap and said connection lead, which is half of the length of the full coil, defines second inductors. Said resonator circuit may be built with said first inductors and said second inductors.

To reduce the space needed on a substrate, an integrated circuit according claim 6 is proposed.

To reduce losses caused by vias, an integrated circuit according to claim 7 is proposed.

Another aspect of the invention is a telecommunication equipment, in particular a multi-band telecommunication equipment, comprising a pre-described integrated circuit.

Yet a further aspect of the invention is the use of an integrated circuit according to a pre-described integrated circuit in broadcast, or telecommunication equipment, in particular in multi-band operation.

Broadcast equipment may be television receivers with multi-frequency band receivers. Telecommunication equipment might be mobile communication equipment, comprising multi-band standard reception means.

These and other aspects of the invention will be apparent from and elucidated with reference to the embodiments described hereinafter.

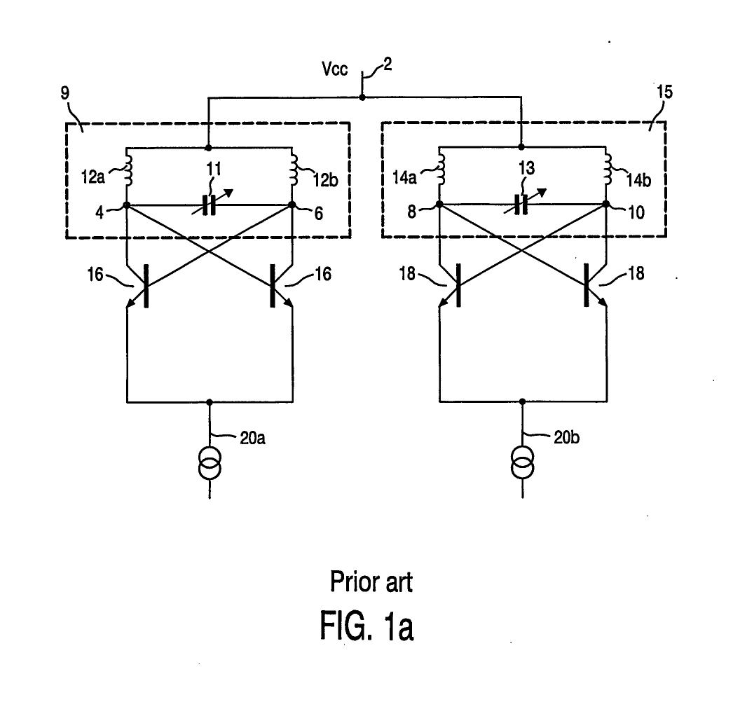

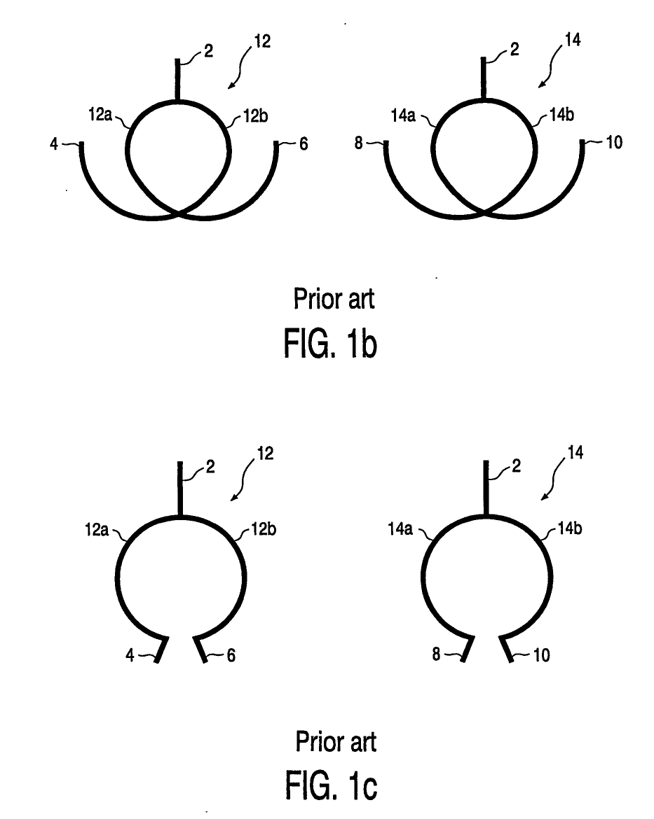

FIG. 1a a conventional multi-band oscillator;

FIG. 1b a conventional multi-turn geometry;

FIG. 1c a conventional single-turn geometry;

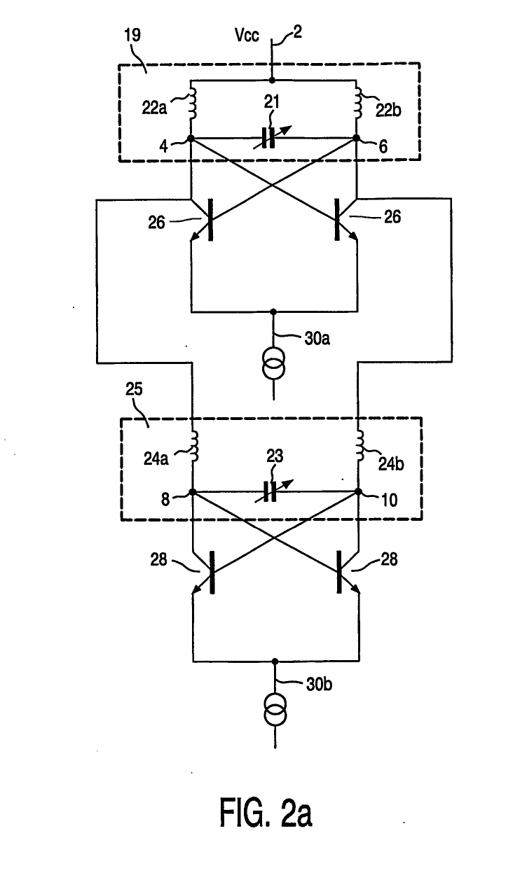

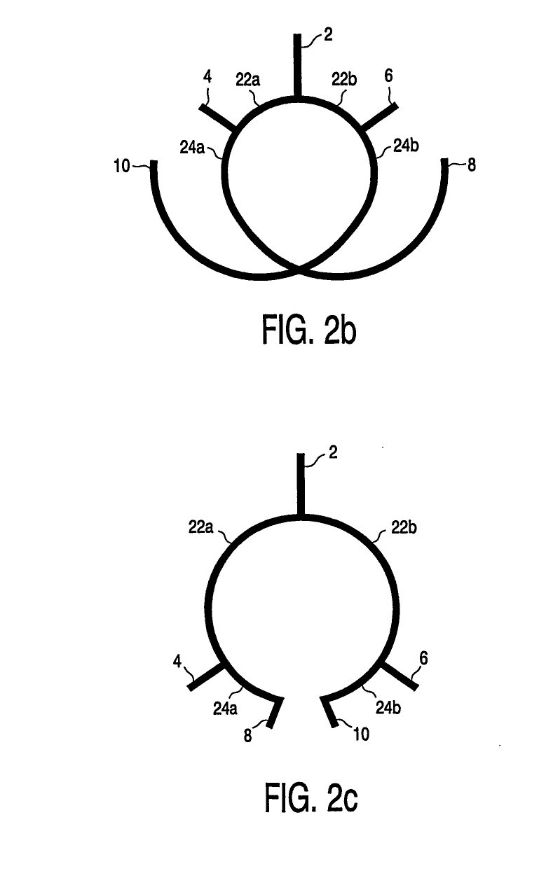

FIG. 2a an inventive multi-band oscillator;

FIG. 2b an inventive multi-turn inductor coil geometry;

FIG. 2c an inventive single-turn inductor coil geometry.

FIG. 1 depicts a conventional multi-band oscillator. For each frequency band, a resonator circuit 9, 15, respectively, together with a transistor 16, 18 is provided. For a first frequency band said resonator circuit 9 comprising inductors 12a, 12b, and a capacitor 11 is provided. This resonator circuit 9 is tuned to said first frequency band. Transistors 16 and 18 are further included.

For a second resonance frequency said second resonator circuit 15 is provided, comprising inductors 14a, 14b and capacitor 13. Transistors 18 are connected to resonator circuit 15.

Bias terminals 2 and 20a, 20a are provided for providing a power supply for said resonator circuits 9, 15 and said transistors 16, 18. Preferably, said bias terminals 20a, 20b provide a constant current.

The depicted multi-band resonator circuit may be realized as an integrated circuit on a substrate. Therefore, said inductors 12a, 12b and 14a, 14b also have to be realized on said substrate. As depicted, the inductors are provided between bias terminal 2 and taps 4, 6, 8, 10. Inductor 12a is provided between bias terminal 2 and tap 4. Inductor 12b is provided between bias terminal 2 and tap 6. Inductor 14a is provided between bias terminal 2 and tap 8. Inductor 14b is provided between bias terminal 2 and tap 10.

An inductor that may be realized on a substrate is depicted in FIG. 1a. The bias terminal 2 and the taps 4, 6, 8 and 10 of the inductors 12a, 12b and 14a, 14b are depicted. Inductors 12a, 12b may be realized by a single coil 12 with a center tap, where bias terminal 2 is connected to said center tap and connection leads of said coil are connected with taps 4, 6. The same applies for inductors 14a, 14b which may also be realized by a single coil 14 with bias terminal 2 connected with said center tap and taps 8, 10 being connected with said connection leads of said coil 14.

As depicted in FIG. 1b the described inductors 12a, 12b and 14a, 14b maybe realized by two coils 12, 14. In FIG. 1b, multi-turn coils 12, 14 for the inductors 12a, 12b and 14a, 14b are depicted. It is shown that for the depicted multi-band resonator circuit of FIG. 1a, two coils 12, 14 have to be provided on the substrate. A first coil 12 provides the inductors 12a, 12b between bias terminal 2 and taps 4, 6, and a second coil 14 provides said inductors 14a, 14b between bias terminal 2, and taps 8, 10.

It is also possible to provide said inductors 12a, 12b and 14a, 14b by single turn coils 12, 14 as depicted in FIG. 1c. Inductor 12a is provided the branch between bias terminal 2, and tap 4 and inductor 12b is provided by the branch between bias terminal 2, and tap 6. Inductor 14a is provided by the branch between bias terminal 2, and tap 8 of coil 14, and inductor 14b is provided by the branch between bias terminal 2 and tap 10 of coil 14.

To provide a multi-band resonator circuit using only one coil, a circuit arrangement according FIG. 2a is proposed.

The resonator circuit 19 comprises inductors 22, a capacitor 21 and is connected to transistors 26. The emitters of the transistors 26 are connected to a current source at bias terminal 30a.

The resonator circuit 25 comprises inductors 24, a capacitor 23 and is connected to transistors 28. The emitters of the transistors 28 are connected to a current source at bias terminal 30b.

Bias terminals 2, 30a, 30b provide a power supply for the resonator circuits 19, 25 and the transistors 26, 28.

The depicted inductors 22a, b, and 24a, b may be realized according to the invention by only one single coil, which has multiple turns, as depicted in FIG. 2b.

A segment between bias terminal 2 and tap 4 realizes inductor 22a and a segment between bias terminal 2 and tap 6 realizes inductor 22b. Inductor 24a is realized by a segment between tap 4 and tap 8 and inductor 24b is realized by a segment between tap 6 and tap 10.

In FIG. 2b a multi-turn coil is depicted. It is also possible that the inductors 22a, b, and 24a, b are realized by one coil, which is a single turn coil, as depicted by FIG. 2c. Again the inductors 22, 24 are realized by the respective segments of the coil. A segment between bias terminal 2 and tap 4 realizes inductor 22a and a segment between bias terminal 2 and tap 6 realizes inductor 22b. Inductor 24a is realized by a segment between bias terminal 2, and tap 8, and inductor 24b is realized by a segment between bias terminal 2, and tap 10.

It is also possible that more than four inductors are realized by said one single coil, as the number of inductors which may be realized by a single coil only relates to the number of intermediate taps arranged on said coil. This number may be increased.

It has to be kept in mind that the inventive geometry of said coil electrically couples the resonance loops of the resonator circuits 19, 25.

By providing a coil according to the invention the space on the substrate used by the inductors may be reduced.

1. Integrated circuit with at least two resonator circuits, in particular for multi-band operation,
each resonator circuit comprising at least two inductors,
each resonator circuit comprising at least one capacitor,
where said at least two inductors and said capacitor provide one resonant circuit, respectively,
characterized in
that said inductors for said at least two resonator circuits are provided by one coil, and
that said coil is mounted on the chip area of said integrated circuit.

2. Integrated circuit according to claim 1, characterized in that said coil comprises one center tap, that said coil comprises intermediate taps, and that said coil comprises two connection leads.

3. Integrated circuit according to claim 1, characterized in that said coil is split into two branches by said center tap and that said intermediate taps divide said branches into segments.

4. Integrated circuit according to claim 3, characterized in that said segments are symmetrically arranged on said branches.

5. Integrated circuit according to claim 1, characterized in that, said inductors are determined by said segments between said center tap, said intermediate taps and said connection leads.

6. Integrated circuit according to claim 1, characterized in that said coil is a multi-turn coil.

7. Integrated circuit according to claim 1, characterized in that said coil is a single-tun coil.

8. Telecommunication equipment, in particular multi-band telecommunication equipment, comprising an integrated circuit according to claim 1.

9. Use of an integrated circuit according to claim 1 in broadcast or telecommunication equipment, in particular multi-band operation.
